(19) United States
(12) Patent Application Publication
(10) Pub. No.: US 2004/0118353 A1
(43) Pub. Date: Jun. 24, 2004

(54) Terrarium water dish and method of use

(75) Inventors: Alan Mark Botterman, Chula Vista, CA (US); David Jack Hanono, Chula Vista, CA (US)

Correspondence Address: PROCOPIO, CORY, HARGREAVES & SAVITCH LLP, 530 B STREET, SUITE 2100, SAN DIEGO, CA, 92101, US

(73) Assignee: T-Rex Products, Inc.

(21) Appl. No.: 10/732,647

(22) Filed: Dec. 10, 2003

Related U.S. Application Data
(60) Provisional application No. 60/432,194, filed on Dec. 10, 2002.

(51) Int. Cl. A01K 7/00

(52) U.S. Cl. 119/72

(57) ABSTRACT

A terrarium water dish for use with an animal terrarium including a rectangular configuration having an internal length, width, and height. The terrarium water dish includes a front wall, an opposite parallel rear wall, an end wall and a hill portion joining the front wall and the rear wall. The hill portion includes a first edge, a second edge, a crest, a first incline between the first edge and the crest, and a second incline between the second edge and the crest. A water zone for holding water is located between the second incline, the front wall, the rear wall, and the end wall. The water zone includes a floor. The terrarium water dish includes a width substantially equal to the internal width of the animal terrarium.

### CROSS-REFERENCE TO RELATED APPLICATION

This application claims priority to prior provisional application no. 60/432,194, filed on Dec. 10, 2002 under 35 U.S.C. §119(e).

### FIELD OF THE INVENTION

The present invention is in the field of terrarium water dishes for terrarium animals such as reptiles, amphibians, and arachnids.

### BACKGROUND OF THE INVENTION

Terrariums are used to house a wide variety of reptiles, amphibians, and arachnids. As used herein, terrarium generally refers to a cage, tank, or like container used as a vivarium to house one or more terrarium animals. Water dishes such as dog bowls are often used in terrariums for providing water for the terrarium animals. Not only may the terrarium animal drink from the water dish, but the terrarium animal may use the water from the water dish for soaking and hydrating. A problem with these water dishes is that they generally have steep, sloped sides that make it difficult for many terrarium animals, especially baby tortoises and lizards, to climb into the water dish for drinking, soaking, or hydrating. Another problem with these water dishes is that they are prone to tipping over. Terrarium animals may climb on the edges of these water dishes or bury underneath the edges of these water dishes and cause the water dish to tip over, spilling water all over the terrarium. A further problem is that the water in these water dishes tends to become contaminated with sand, leaves, animal waste, and other contaminants, making the water undesirable for drinking, soaking, or hydrating and requires frequent changing. A need therefore exists for a terrarium water dish eliminates the aforesaid problems with the prior art.

### SUMMARY OF THE INVENTION

An aspect of the present invention involves a terrarium water dish for use with an animal terrarium including a rectangular configuration having an internal length, width, and height. The terrarium water dish includes a front wall, an opposite parallel rear wall, an end wall and a hill portion joining the front wall and the rear wall. The hill portion includes a first edge, a second edge, a crest, a first incline between the first edge and the crest, and a second incline between the second edge and the crest. A water zone for holding water is located between the second incline, the front wall, the rear wall, and the end wall. The water zone includes a floor. The terrarium water dish includes a width substantially equal to the internal width of the animal terrarium.

Another aspect of the present invention involves a method of using a terrarium water dish. The terrarium water dish is for use with an animal terrarium including a rectangular configuration having an internal length, width, and height. The method includes the steps of providing a terrarium water dish including a front wall, an opposite parallel rear wall, and an end wall at least partially defining a water zone for a terrarium animal, a terrarium animal access portion sized and shaped to allow the terrarium animal to easily access and exit the water zone and the terrarium water dish having a width substantially equal to the internal width of the animal terrarium; placing the terrarium water dish into the animal terrarium so that the end wall of the terrarium water dish is adjacent to an end wall of the animal terrarium, the front wall of the terrarium water dish is adjacent to one of the front wall and the rear wall of the animal terrarium, and the rear wall of the terrarium water dish is adjacent to one of the front wall and the rear wall of the animal terrarium.

Further objects and advantages will be apparent to those skilled in the art after a review of the drawings and the detailed description of the preferred embodiments set forth below.

### BRIEF DESCRIPTION OF THE DRAWINGS

FIG. 1 is a perspective view of an embodiment of a terrarium water dish shown in an exemplary terrarium.

FIG. 2 is a top plan view of the terrarium water dish illustrated in FIG. 1.

FIG. 3 is a cross-sectional view of the water dish of FIG. 2 taken along lines 3-3 of FIG. 2.

### DETAILED DESCRIPTION OF PREFERRED EMBODIMENTS

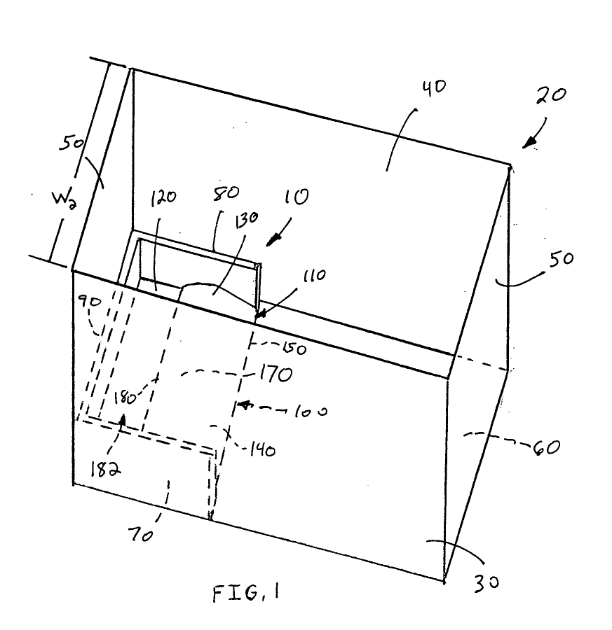

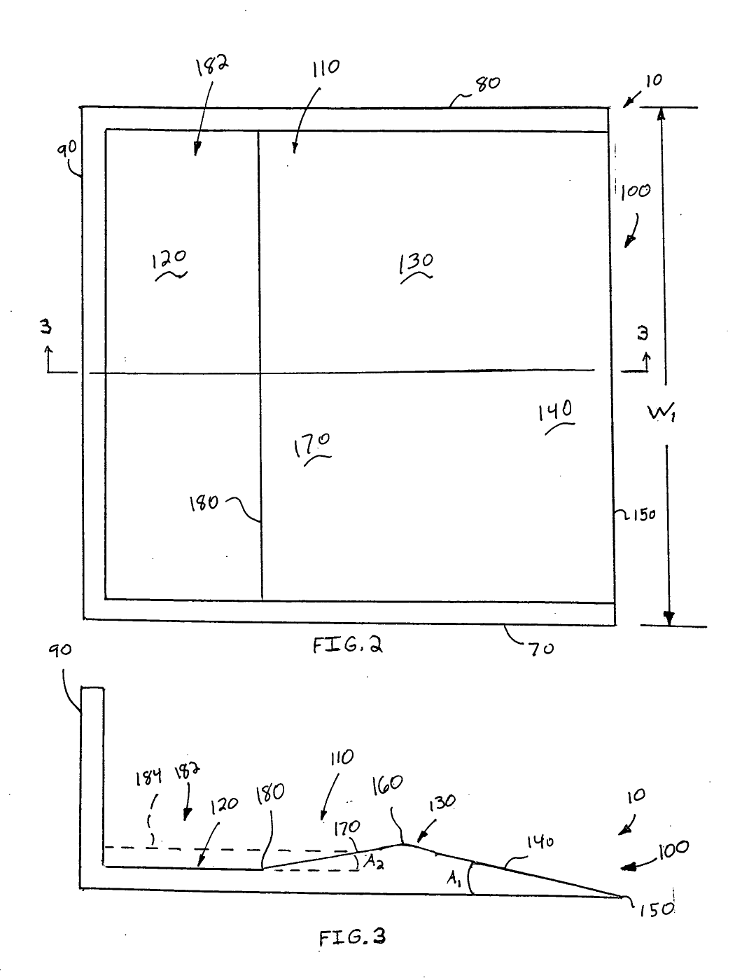

With reference to FIGS. 1-3, an embodiment of a terrarium water dish 10 for use with a terrarium 20 will now be described. The terrarium 20 has a generally rectangular or square block configuration and includes front wall 30, rear wall 40, end walls 50, and floor 60. The terrarium 20 may also include a cover (not shown). Although the terrarium 20 is shown as having a length greater than the height, in alternative embodiments, the height may be equal to or greater than the length.

The terrarium water dish 10 is preferably cast or molded out of a polyresin material. The terrarium water dish includes a front wall 70, a rear wall 80, an end wall 90, and an open end 100 opposite the end wall 90. The terrarium water dish 10 includes a floor 110 with a substantially flat portion 120 and a hill or beach portion 130. A bottom of the front wall 70, the rear wall 80, and the end wall 90 form the boundaries of the floor 110. The terrarium water dish 10 has a constant width W₁ substantially equal to the interior width W₂ between the front wall 30 and the rear wall 40.

The beach portion 130 will now be described in more detail. The beach portion 130 includes a first incline or slope 140 that extends between a low first edge 150, which is less than 1 cm. In height at the open end 100 of the water dish 10 to a crest 160. A second incline or slope 170 extends between the crest 160 and a second edge 180 at a junction of the beach portion 130 and the flat portion 120. A water zone 182 exists above the flat portion 120 and between the second incline 170 and the walls 70, 80, 90 where water 184 is located.

Although the crest 160 is shown at being somewhat pointed, the crest 160 and the inclines 140, 170 may also have a more curved configuration. The edges 150, 180 may also be other shapes besides straight (e.g., curvilinear). The water dish 10 may also have one or more zones (e.g., food zone) in addition to the water zone 182.

The first incline 140 is inclined at a first angle A₁ relative to a flat undersurface 190 of the water dish 10. The first angle A₁ is preferably 1-35 degrees. The second incline 170 is inclined at a second angle A₂ relative to the flat portion 120. The second angle A₂ is preferably 1-45 degrees. The first angle A₁ is preferably smaller than the second angle A₂, making the first incline 140 more gradual than the second incline 170 In an embodiment of the water dish 10, where the beach portion 130 has a curved configuration and one or both of the inclines 140, 170 are curved slopes, the first angle A₁ is the average angle of the first incline 140 and the second angle A₂ is the average angle of the second incline 170.

The combination of the open end 100, a low first edge 150, and the small first angle A₁ of the first incline 140 makes it easy for terrarium animals, especially small terrarium animals such as baby tortoises and lizards, to climb into the water dish 10 for drinking, soaking, or hydrating.

The second angle A₂ is large enough so that the second incline 170 contains the water 184 in the water zone 182 without it easily splashing or flowing out, but small enough so that terrarium animals, especially small terrarium animals such as baby tortoises and lizards, can easily climb up the second incline 170 and out of the water zone 182. The second incline 170 and the height of the crest 160 determines the maximum height of the water 184.

The gradual hill or beach portion 120 with the flat undersurface 190, along with the width W₁ of the water dish being substantially equal to the width W₂ of the interior of the terrarium 20, prevents the water dish 10 from being tipped over by the terrarium animal. The width W₁ of the water dish being substantially equal to the width W₂ of the interior of the terrarium 20, the walls 70, 80, 90, and the raised beach portion 130 inhibit contaminants from entering the water and inhibits water from being splashed out of the water zone of the dish 10.

It should be noted, the terrarium water dish 10 may come in different sizes to accommodate different-sized animal terrariums 20. For example, but not by way of limitation, the terrarium water dish 10 may come in a 10 in. width, a 12 in. width, and a 15 in. width to accommodate terrariums 20 of similar size.

In use, the terrarium water dish 10 is placed directly on the floor 60 or on the substrate on the floor 60 of the terrarium 60 with the front wall 70, rear wall 80, and end wall 90 of the terrarium water dish 10 abutting or adjacent to (without any substantial gap therebetween) the front wall 30, the rear wall 40, and the end wall 50, respectively, of the terrarium 20. Although the terrarium water dish 10 is shown adjacent to the left end wall 50, the terrarium water dish 10 may be located adjacent the right end wall 50. The terrarium water dish 10 includes a width W₁ substantially equal to the internal width W₂ of the animal terrarium 20. As used herein, “a width W₁ substantially equal to the internal width W₂” means that gaps of less than 1 cm. exist between the walls 30, 40 of the terrarium water dish 10 and the walls 70, 80 of the terrarium 20. To position the water dish 10 against one of the end walls 50, the water dish 10 may be handled by grabbing it in the beach portion 130. After the terrarium water dish 10 is positioned in the terrarium, the water zone 182 is filled with water 184. To remove the water dish 10 from the terrarium 20 for cleaning, one's fingers may be inserted under the undersurface 190 of the beach portion 130, and the water dish 10 may be pulled out of the terrarium 20 by handling the water dish 10 in the beach portion 130. The water dish 10 may also include one or more handles or gripping portions for handling the water dish 10.

It will be readily apparent to those skilled in the art that still further changes and modifications in the actual concepts described herein can readily be made without departing from the spirit and scope of the invention as defined by the following claims.

What is claimed is:

1. A terrarium water dish for use with an animal terrarium including a rectangular configuration having an internal length, width, and height, comprising:
a front wall and an opposite parallel rear wall;
an end wall and a hill portion joining the front wall and the rear wall, the hill portion including a first edge, a second edge, a crest, a first incline between the first edge and the crest, and a second incline between the second edge and the crest;
a water zone for holding water located between the second incline, the front wall, the rear wall, and the end wall, the water zone including a floor,
wherein the terrarium water dish includes a width substantially equal to the internal width of the animal terrarium.

2. The terrarium water dish of claim 1, wherein the first incline is sloped at a first angle and the second incline is sloped at a second angle, and the second angle is greater than the first angle.

3. The terrarium water dish of claim 1, wherein the first incline is sloped at a first angle of 1-30 degrees.

4. The terrarium water dish of claim 1, wherein the second incline is sloped at a second angle of 1-45 degrees.

5. The terrarium water dish of claim 1, wherein the hill portion has a curved configuration.

6. The terrarium water dish of claim 1, wherein at least one of the first incline and the second incline does not have a constant slope.

7. The terrarium water dish of claim 1, wherein at least one of the first incline and the second incline has a constant slope.

8. The terrarium water dish of claim 1, wherein at least one of the first edge and the second edge is straight.

9. The terrarium water dish of claim 1, wherein at least one of the first edge and the second edge is not straight.

10. The terrarium water dish of claim 1, wherein the terrarium water dish includes an open end adjacent the first edge.

11. The terrarium water dish of claim 1, wherein the first edge has a height less than 1 cm.

12. The terrarium water dish of claim 1, wherein the water dish includes one or more zones in addition to the water zone.

13. A method of using a terrarium water dish, the terrarium water dish for use with an animal terrarium including a rectangular configuration having an internal length, width, and height, comprising the steps of:
providing a terrarium water dish including a front wall, an opposite parallel rear wall, and an end wall at least partially defining a water zone for a terrarium animal, a terrarium animal access portion sized and shaped to allow the terrarium animal to easily access and exit the water zone, and the terrarium water dish having a width substantially equal to the internal width of the animal terrarium;
placing the terrarium water dish into the animal terrarium so that the end wall of the terrarium water dish is adjacent to an end wall of the animal terrarium, the front wall of the terrarium water dish is adjacent to one of the front wall and the rear wall of the animal terrarium, and the rear wall of the terrarium water dish is adjacent to one of the front wall and the rear wall of the animal terrarium.

14. The method of claim 13, wherein the terrarium animal access portion includes a hill portion having a first edge, a second edge, a crest, a first incline between the first edge and the crest, and a second incline between the second edge and the crest.

15. The method of claim 14, wherein the first incline is sloped at a first angle and the second incline is sloped at a second angle, and the second angle is greater than the first angle.

16. The method of claim 14, wherein the first incline is sloped at a first angle of 1-30 degrees and the second incline is sloped at a second angle of 1-45 degrees.

17. The method of claim 13, wherein the water dish includes one or more zones in addition to the water zone.
